(19) United States
(12) Patent Application Publication
(10) Pub. No.: US 2011/0013001 A1
(43) Pub. Date: Jan. 20, 2011

(54) DIGITAL PENS AND A METHOD FOR DIGITAL RECORDING OF INFORMATION

(76) Inventors: Thomas Craven-Bartle, Lund (SE); Petter Ericson, Lund (SE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/863,910

(22) PCT Filed: Jan. 27, 2009
(86) PCT No.: PCT/SE2009/050078

§ 371 Date: Oct. 6, 2010

Related U.S. Application Data
(60) Provisional application No. 61/006,704, filed on Jan. 28, 2008.

(30) Foreign Application Priority Data
Jan. 28, 2008 (SE) 0800203-2

(51) Int. Cl. H04N 7/18

(52) U.S. Cl. 348/61; 348/E07.085

(57) ABSTRACT

A digital pen is provided with an optical system with at least one sensor for capturing images of a patterned surface and at least one light source for illuminating the patterned surface when images are captured by the at least one sensor. In order to solve the problem that the sensor is sometimes blinded by specularly reflected light when the digital pen is used on a glossy surface, the optical system is adjustable between at least two image capturing states in which images are captured with a different geometrical arrangement of the at least one sensor and the at least one light source. As a supplement or alternative, the digital pen may illuminate the patterned surface with linearly polarized light having a first polarization direction and further be provided with a linear polarizer in front of the image sensor, which polarizer has a second different polarization direction, preventing specularly reflected light from reaching the sensor.

### FIELD OF INVENTION

The present invention relates to digital pens and a method for digital recording of information using a patterned surface.

### BACKGROUND OF THE INVENTION

It is known to digitally record pen strokes formed on a surface by means of a digital pen which captures images of the surface while the pen strokes are formed. To enable the digital recording of the pen strokes the surface is provided with a pattern which makes it possible to determine the relative or absolute position of the digital pen on the surface using the content of the captured images.

One example of a digital pen operating on an absolute position-coding pattern is disclosed in WO 01/26032 A1. The pen comprises a light-emitting diode for illuminating the surface, an optical sensor for imaging the surface and a processor for decoding positions from the images.

It has been observed that decoding problems may sometimes occur when a digital pen is used on a glossy or shiny surface, such as a coated paper or a whiteboard, because in some images the brightness may be so high that it is difficult or even impossible to discern the pattern.

### SUMMARY

The above-mentioned decoding problems may at least partly be solved by a digital pen according to claim 1, a digital pen according to claim 9 and a method according to claim 12.

According to a first aspect of the invention, there is provided a digital pen for digital recording of information using a patterned surface, comprising an optical system with at least one sensor for capturing images of the patterned surface while the digital pen is operated on the patterned surface and at least one light source for illuminating the patterned surface when images are captured by the at least one sensor; wherein the optical system is adjustable between at least two image capturing states in which images are captured with a different geometrical arrangement of the at least one sensor and the at least one light source.

According to a second aspect, there is provided a digital pen for digital recording of information using a patterned surface, comprising an optical system with at least one sensor for capturing images of the patterned surface while the digital pen is operated on the patterned surface and at least one light source for illuminating the patterned surface when images are captured by the at least one sensor; wherein the digital pen is configured to illuminate the patterned surface with linearly polarized light having a first polarization direction and wherein a linear polarizer having a second different polarization direction is provided in front of the at least one image sensor.

According to a third aspect, there is provided a method for digital recording of information using a patterned surface and a digital pen which comprises an optical system with at least one sensor for capturing images of the patterned surface while the digital pen is operated on the patterned surface and at least one light source for illuminating the patterned surface when images are captured by the at least one sensor, the method comprising capturing a first image in a first image capturing state using a first geometrical arrangement of the at least one light source and the at least one sensor and capturing a second image in a second image capturing state using a second geometrical arrangement of the at least one light source and the at least one sensor.

The invention is based on the realization that the decoding problems that sometimes appear on a glossy or smooth surface result from specularly reflected light, which for certain orientations of the pen reaches the image sensor and dominates parts of the image or the whole image, making it difficult to discern the pattern on the surface.

This problem can be solved by providing the pen with an optical system with at least two image capturing states, which can be selectively activated and in which images are captured with a different geometrical arrangement of the at least one sensor and the at least one light source. The digital pen may for instance have two light sources which are placed at a distance from each other and which may be used selectively. Due to the different geometrical arrangements, any problem with specularly reflected light occurs for different pen orientations in the different image capturing states. Thus the optical system can be controlled to reduce the problem with specular reflection.

If the light from the light source is linearly polarized in a first direction, an alternative or supplementary solution may consist in placing a linear polarizer having a second different polarization direction in front of the image sensor. The solution is based on the understanding that linearly polarized light retains its polarization when specularly reflected, but not when scattered. The linear polarizer in front of the image sensor may thus prevent specularly reflected light from reaching the image sensor, while still transmitting a part of the scattered useful light to the image sensor.

### BRIEF DESCRIPTION OF DRAWINGS

FIGS. 1a and 1b schematically shows a part of a digital pen.

FIG. 2 schematically illustrates a geometrical arrangement of components in a digital pen.

FIG. 3 is an exemplary diagram indicating decoding success rate for different orientations of a digital pen having a geometrical arrangement of components according to FIG. 2.

FIGS. 4-6 are schematical partial views of digital pens with differently configured optical systems.

FIGS. 7a and 7b are diagrams showing decoding success rate as a function of orientation for different image capturing states of the digital pen of FIG. 4.

FIGS. 8a-8c are diagrams showing decoding success rate as a function of orientation and illustrating how problems with specularly reflected light can be avoided.

FIG. 9 schematically shows a part of a digital pen with linear polarizers.

FIG. 10 is a flow chart which schematically shows how a digital pen may be controlled to avoid problems with specularly reflected light.

FIG. 11 schematically shows an exemplary digital pen.

### DETAILED DESCRIPTION OF EMBODIMENTS

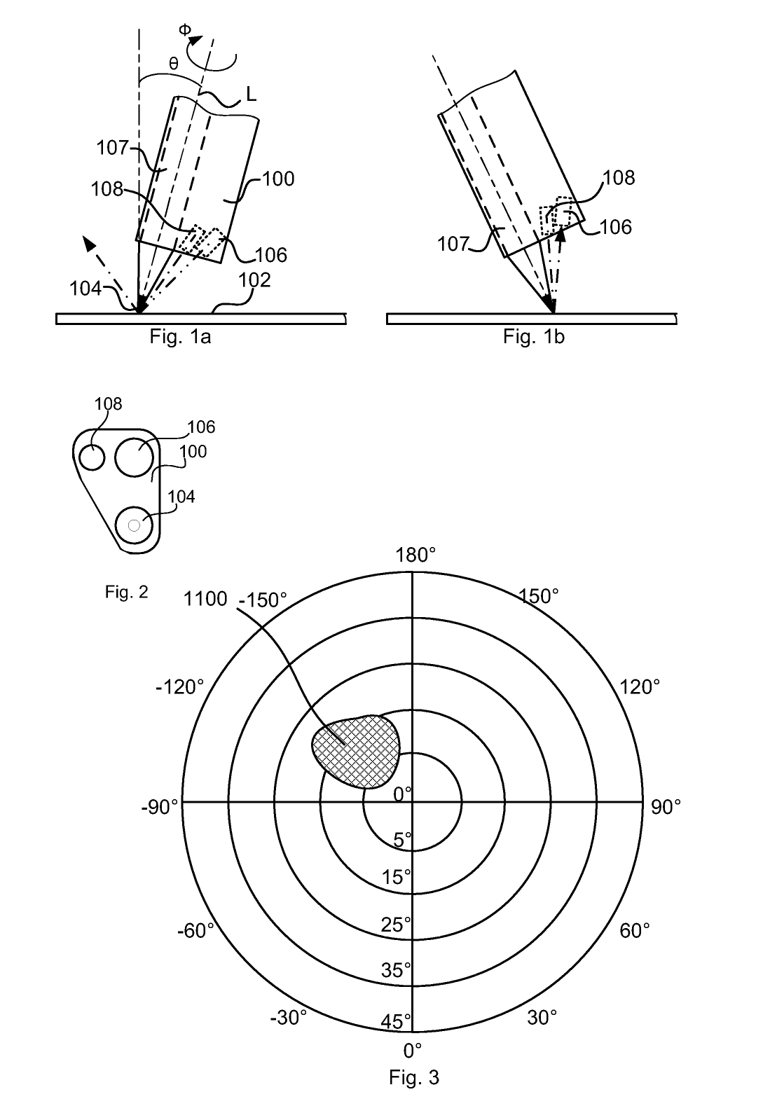

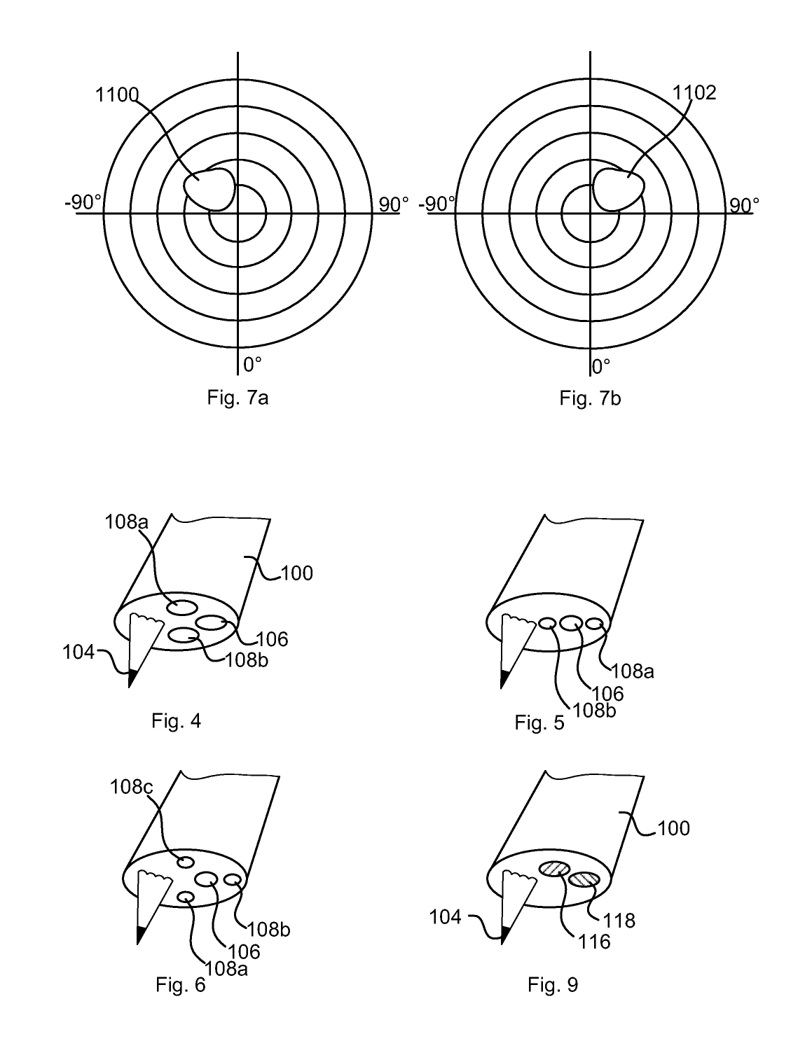

Reference will now be made in detail to exemplary embodiments of the invention as illustrated in the accompanying drawings. Wherever possible, the same reference numbers are used throughout the drawings to refer to the same or like parts. First the problem with specular reflection will be explained with reference to FIGS. 1-3. Then different solutions to the problem will be described with reference to FIGS. 4-11.

FIGS. 1a and 1b schematically show a part of a digital pen 100 for digital recording of pen strokes from a surface 102 of a base 103. The surface may be provided with a pattern (not shown), allowing relative or absolute positioning on the surface. The pen 100 comprises a marking element 107 with a tip 104, and an optical system including an image sensor 106 for capturing images of the surface within its field of view in the vicinity of tip 104 and a light source 108 for illuminating at least the area of the surface to be imaged. The optical axis of image sensor 106 is shown with a double-dot-dashed line and the optical axis of light source 108 with a dot-dashed line. A longitudinal pen axis L is defined by marking element 107 and its tip 104.

Since tip 104 is the only point of contact between pen 100 and surface 102, the orientation of the pen may vary considerably during use of the pen. The orientation of the pen may be defined by tilt and skew, where tilt of the pen is an angle θ between the normal to the surface and pen axis L, and skew is an angle Φ around pen axis L.

When light from light source 108 reaches surface 102, part of the light will be specularly reflected, i.e. reflected at the same angle as the incident light, and part will penetrate into base 103 and scatter back. The relative amounts depend of course on the properties of the surface, but a glossy surface will typically result in a higher amount of specularly reflected light. Certain kinds of toners and printing inks may also have the same effect. Since light is scattered back in all directions, the amount of light radiating in any given direction is relatively low compared to the amount of light incident upon the surface. The direction of the specularly reflected light is shown by the arrowed dot-dashed line in FIGS. 1a and 1b.

For certain orientations of the pen, the optical axis of image sensor 106 may essentially coincide with the direction of specularly reflected light from base 103. This case is schematically illustrated in FIG. 1b. Because of the losses associated with the scattering of light in the base, the brightness of the specularly reflected light will be much higher than that of the scattered light reaching image sensor 106. The image will thus be dominated by the bright specularly reflected light which makes it difficult or even impossible to discern any pattern provided on the surface.

FIG. 3 illustrates the effect of the specular reflection by a diagram showing decoding success rate for different orientations of an electronic pen. Compared to the pen shown in FIGS. 1a and 1b, the digital pen used for obtaining the diagram had a slightly different geometrical arrangement of tip 104, image sensor 106 and light source 108 as shown in FIG. 2. In the diagram of FIG. 3, the tilt angle is mapped such that 0° is in the centre of the diagram and 45° is at the outer circumferential of the diagram, and the skew angle is mapped between −180° and 180°. Marked field 1100 indicates orientations for which the decoding is deemed unsuccessful or unsatisfactory. For orientations outside marked field 1100 the decoding is deemed satisfactory or successful. The unsatisfactory decoding results from specular reflection of the light from the light source into the image sensor upon use of the digital pen on a glossy surface.

The effect of specularly reflected light can be avoided or at least reduced by providing a digital pen with an optical system which is adjustable between at least two image capturing states in which images are captured by a different geometrical arrangement of the image sensor(s) and the light source(s). Since the problem with specularly reflected light occurs for different orientations of the pen in the different image capturing states, the problem can be avoided by using the image capturing states selectively.

In a first embodiment, schematically illustrated in FIG. 4, the digital pen 100 may have two light sources 108a and 108b arranged at a distance from each other and at a distance from image sensor 106. Since the combination of light source 108a and image sensor 106 will have a different geometrical arrangement compared to the combination of light source 108b and image sensor 106, the problem with specular reflection will occur for different orientations of the pen in the different image capturing state.

The light sources may be placed in many different ways in relation to the light source. In fact the light sources may be placed in any configuration so long as they are able to illuminate the desired area on the surface and so long as they are arranged at some distance from each other to provide a spatial change of the illumination properties. FIG. 5 illustrates for instance an embodiment where tip 104, light sources 108a, 108b and image sensor 106 are aligned, one light source being placed at either side of the image sensor.

In another embodiment digital pen 100 may have more than two light sources, for instance three light sources 108a-c, as illustrated in FIG. 6, where the light sources are placed in the corners of a triangle with image sensor 106 in the middle. In this embodiment, one or more of the light sources may be activated at the time to provide for two or more different image capturing states.

In a further embodiment, the digital pen may have only one light source but two or more image sensors, which are placed at a distance from each other. The sensors may be selectively activated or may be used in parallel. The configuration may for instance be like in any one of FIGS. 4-6, where the light sources are replaced by image sensors and the image sensor replaced by a light source.

In yet another embodiment, the light source or the image sensor or both may be movable between at least two different positions to provide for two different image capturing states. The different positions can be achieved by angling the component(s) or by moving it/them transversely to the image axis or by a combination thereof.

The light source(s) and/or the image sensor(s) may include one or more reflectors or refractors. These may be used to obtain the different image capturing states. More particularly one or more reflectors or refractors may be moveable between at least two different positions to provide for different image capturing states.

In these two latter cases, two different image capturing states may thus be obtained using only one light source and only one image sensor. Yet another way of providing two image capturing states using one light source and one image sensor would be to have a larger image sensor so that different image capturing states could be obtained by using different parts of the sensor.

FIGS. 7a and 7b show diagrams of decoding success rate as a function of orientation of the same kind as FIG. 3 with the same mapping of tilt and skew angles as in FIG. 3 for a digital pen according to the embodiment of FIG. 4. The diagram of FIG. 7a shows the decoding success rate when first light source 108a is used, whereas the diagram of FIG. 7b shows the decoding success rate when second light source 108b is used. Field 1100 in FIG. 7a and field 1102 in FIG. 7b indicate orientations for which decoding is unsatisfactory. These fields 1100 and 1102 may thus be called “blind spots” of the digital pen. As is evident from the figures, these fields do not overlap in this case and consequently the light sources can be selectively activated to avoid the fields where decoding may fail due to specularly reflected light reaching the image sensor. If the blind spots overlap, a third or more light source with a non-overlapping blind spot may be used.

In the following, different methods of selectively activating or using the different image capturing states of the optical system will be described. For the sake of simplicity, the description will be made with reference to an optical system including two light sources 108a and 108b and one image sensor 106, as illustrated in FIG. 4, but the description is equally valid for an optical system where the different image capturing states are provided by other components as described above.

In one embodiment, light sources 108a and 108b are triggered in an alternating way, so that every second image is captured while a first of the light sources illuminates the surface and every other image is captured while a second of the light sources illuminates the surface. In this way at least every second image should be captured without interference from specularly reflected light. An improved performance might be achieved if the image capturing frequency is increased.

It may also be conceivable to use other fixed schedules for switching between the different image capturing states, especially if the blind spots are asymmetrically located in the decoding success rate-to-orientation diagram and/or if they are of different sizes.

In another embodiment, the orientation of digital pen 100 may be tracked, so that a switch from one light source to the other can be carried out when it is detected that the pen orientation approaches or enters the blind spot in the decode success rate-to-orientation diagram where decoding success rate is unsatisfactory. The pen orientation may be sensed by orientation sensing means of the digital pen, which may include different kinds of gyros or a processor unit which is configured to calculate the orientation of the pen based on information extracted from the images of the pattern on the surface. The orientation can for example be determined by using an algebraic model together with knowledge of the predetermined pattern, e.g. as described in WO 01/71654 A1, which is hereby incorporated in its entirety by reference. The sensed or calculated pen orientation may be compared with previously determined orientations for which the decoding success rate has been found to be unsatisfactory/satisfactory in order to establish whether the current pen orientation is close to or in the blind spot. Indications of pen orientations that correspond to one or more blind spots for the different image capturing states may be stored in the digital pen. Furthermore, a plurality of successive orientation values may be used to find out if the pen orientation approaches an area where decoding may be a problem for the light source-image sensor configuration used at present. Also calculated or measured values of e.g. pen angular speed or and/or pen angular acceleration may be taken into account in order to predict whether the pen orientation approaches a blind spot of the currently used image capturing state. In an alternative embodiment the sensed or calculated pen orientation is used as an index into a look-up table stored in the pen which for each pen orientation indicates whether or not a switch of light source should be carried out, and, in the case of more than two light sources, to which light source.

In yet another embodiment, a switch from one light source to the other may be based on an evaluation of decoding success. If the digital pen detects that decoding fails or gives an unsatisfactory result for one image or a predetermined number of successive images, the presently used light source may be deactivated and the other light source activated. Other criteria, such as image quality, may also be used for determining when the switch over to the other light source is to take place.

In one embodiment intensity values from one or more captured images can be used as a measure of image quality. The image may for instance be divided into smaller parts or cells and a maximum intensity value or an average intensity be determined for each cell. The combined results for the cells may then be used to determine if the image sensor or a part thereof is blinded by specularly reflected light so that a switch to another image capturing state is to be carried out. A combined result may e.g. be the number of cells where the maximum intensity value is equal to the highest possible intensity value. This combined result may then be compared to a predetermined threshold value in order to assess whether the switch should be carried out. WO 03/030082 describes how exposure control may be performed in a digital pen based on intensity values from different parts of an image. A process for determination of image quality based on intensity values may take advantage of intermediary results calculated in an exposure control process or be carried out as a separate process.

In another embodiment, a light source of the pen is turned on briefly with low intensity between the capturing of the images used for decoding. Then one or more small parts of the sensor, where each part may be for instance 2 by 2 pixels, are read, and based on the intensity values of the pixels of the read part(s), it is assessed whether specularly reflected light reaches the sensor or not, which in turn results in a decision to switch image capturing state or not. The assessment according to this embodiment can be carried out in a very short time, because only a few pixels need to be read from the sensor. Also any charging of the light source is affected to a minimal extent, and so is power consumption.

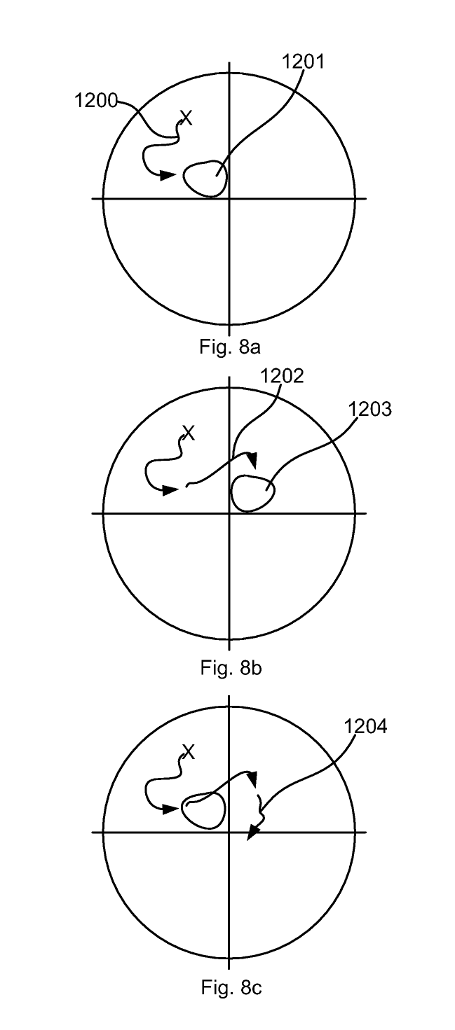

FIGS. 8a-8c show schematic diagrams of decoding success rate as a function of orientation for a digital pen with two light sources and one image sensor like in FIG. 4. The mapping of tilt and skew angles is the same as in FIG. 3. FIG. 8a shows the diagram applicable for the light source that is activated when the user starts using the digital pen with X indicating the orientation of the pen at the start. During subsequent operation of the pen, the orientation changes as indicated by arrowed line 1200. At the end of arrowed line 1200, the orientation approaches blind spot 1201 where decoding may be a problem because of specularly reflected light. The approach towards this field may be detected, as described above, by determining the current orientation of the pen. When the approach of blind spot 1201 is detected, the first light source is deactivated and a second light source is activated, whereby the decoding success rate to orientation diagram shown in FIG. 8b becomes the applicable one. The orientation continues to change according to second arrowed line 1202. At the end of second arrowed line 1202, the orientation approaches blind spot 1203 where decoding may be a problem because of specularly reflected light. In a similar way as described above, the pen switches back to the first light source, whereby the decoding success rate to orientation diagram shown in FIG. 8a again becomes the applicable one. However, to better illustrate the course of events, the diagram of FIG. 8a is repeated in FIG. 8c with the arrows showing the change of pen orientation during the use of the pen. The orientation continues to change according to third arrowed line 1204 without entering any field where decoding problems may be expected. By operating the optical system in this way, an improved decoding rate may be achieved.

According to an alternative or supplementary embodiment, the problem with specularly reflected light may be avoided or reduced by illuminating the surface with linearly polarized light of a first polarization direction and placing a linear polarizer having a second different polarization direction in front of the image sensor.

This solution is based on the understanding that linearly polarized light which is specularly reflected in a surface will to a large extent retain its linear polarization. On the contrary, light that penetrates through the surface and scatters in the base, will not retain its linear polarization. Thus by placing a first polarizer in the optical path between the light source and the surface, and a second polarizer in the optical path between the surface and the image sensor and with its polarizing direction substantially perpendicularly to that of the first polarizer, only light that has been scattered in the base will reach the image sensor. In this way, the negative effects of the specular reflection can be avoided. A drawback with this solution may be that the polarizers may absorb a relatively large part of the light. These losses can be reduced by using a light source that by itself emits linearly polarized light, e.g. a laser diode. In this case the first polarizer need not be used. Also, two or more light sources may be used to compensate for absorption of light by the polarizers. In such case, linear polarizers with substantially the same polarization direction should be placed in front of the light sources. Alternatively, light sources that emit linearly polarized light of the same polarization direction may be used.

If one or more reflector or other components that affect the polarization direction are used in the optical path between the first and second polarizers, account of this should be taken when selecting the polarizing direction of the second polarizer. Generally, the polarizing direction of the second polarizer should be selected such that the transmission intensity of the light linearly polarized by the first polarizer is minimized.

FIG. 9 schematically illustrates a part of a digital pen 100, where a first linear polarizer 118 is placed in front of the light source and a second linear polarizer 116 is placed in front of the image sensor. The different polarization directions are illustrated with the oblique lines. Ideally the polarization directions are perpendicular to each other, but the polarizers may also be placed in other angular configurations that will absorb most of the specularly reflected light.

In the embodiment above, the polarizer(s) is used permanently. In another embodiment, the polarizer(s) may be used only when decoding problems due to specularly reflected light is expected or detected. This use corresponds to that described above when two or more light sources or image sensors are selectively used. More particularly, image capturing carried out without a polarizer which absorbs specularly reflected light will represent a first image capturing state and image capturing using a polarizer that absorbs specularly reflected light will represent a second image capturing state. The polarizer(s) may be moved into the optical path or just activated when to be used.

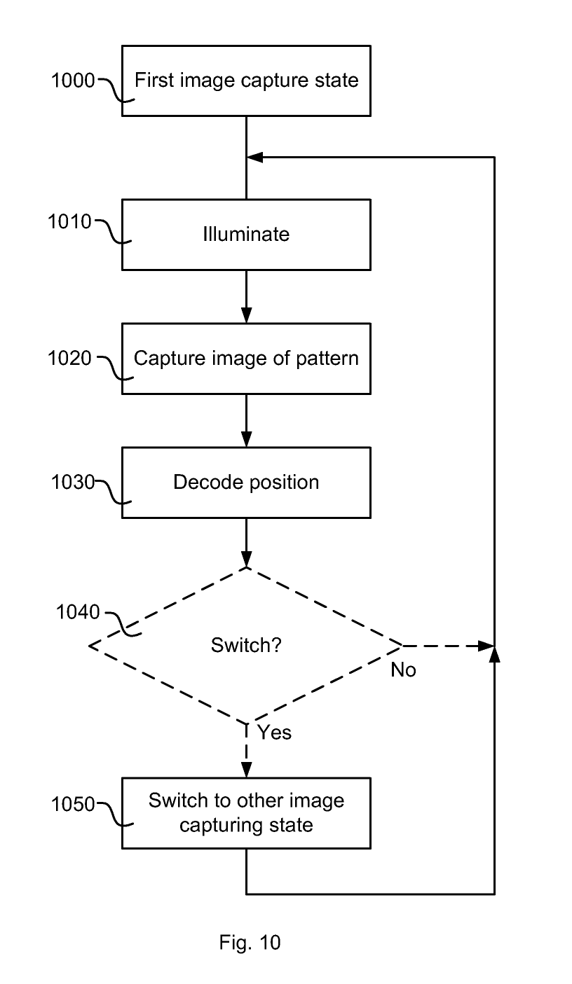

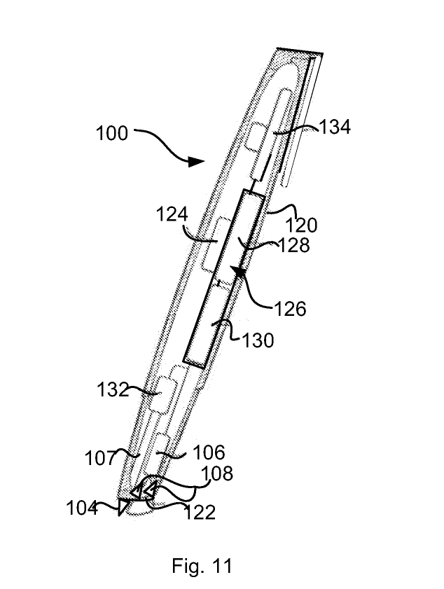

FIG. 10 is a flow chart schematically illustrating how an optical system of a digital pen with two image capturing states, such as digital pen 100 in FIG. 4, may be controlled to avoid problems caused by specularly reflected light. As indicated by box 1000, it is assumed that a first image capturing state is used when the digital pen is activated. In a first step 1010 of the method, the light source used in the current image capturing state is turned on to illuminate a surface at the vicinity of the tip. While the illumination is on, an image is captured by the image sensor, step 1020. In the following step 1030, position decoding is carried out or at least attempted. The result of the position decoding may be satisfactory or unsatisfactory because it failed or because the result was deemed to be uncertain. In one embodiment, the next step is a mandatory switch to the other image capturing state, step 1050, so that every second image is captured in the one image capturing state and the other images in the other image capturing state. In another embodiment, the position decoding step is followed by an evaluation step 1040, in which it is determined whether or not a switch to the other image capturing state is to be carried out. As indicated above, the evaluation may be based on one or more orientation values, the result of the decoding step, assessed image quality or other measures. If the result of the evaluation step is that image capturing state is to be changed, the switch to the other image capturing state is carried out in step 1050 and then the flow returns to step 1010, else the flow returns directly to step 1010 and the next image is captured in the same image capturing state.

If the optical system includes more than two image capturing states, the method may also include a selection step in which the specific image capturing state to which a switch is to be carried out is selected.

The method may be carried out in its entirety in a digital pen, but may also be divided between the digital pen and one or more external units which communicate with the pen. The steps of the method may be implemented by software, hardware, or firmware.

Above, a digital pen 100 with an optical system designed for reducing decoding problems caused by specularly reflected light has been described with reference to FIGS. 4-6 and 9. As already indicated such a digital pen may comprise a marking element 107 with a tip 104, one or more image sensors 106 and one or more light sources 108 placed at a distance from each other. The marking element 107 may or may not be adapted to leave marks on the surface when the digital pen is used. If the marking element 107 is adapted to leave visible marks on the surface, it may contain structure such as an ink cartridge, a roller ball, a pencil, a felt tip cartridge or even a complete whiteboard or marker pen. The marking element 107 may be replaceable. Each image sensor 106 may for instance include a CCD or CMOS sensor or other camera-like device. It may be sensitive to visible and/or invisible light. Each light source 108 may include one or more selectively operable LEDs or laser diodes or other illuminating devices. The digital pen need not be of any particular shape or proportion, so long as it is capable of being manipulated by a user's hand for forming pen strokes on the surface.

FIG. 11 shows more in detail an exemplary digital pen 100 in which an optical system for reducing problems caused by specularly reflected light may be used. The pen has a pen-shaped casing or shell 120 that defines a window or opening 122, through which the images are recorded.

The optical system of the exemplary digital pen 100 in FIG. 11 comprises two illuminating light sources 108, a lens arrangement (not shown in the Figure) and an optical image sensor 106. The light sources 108, suitably light-emitting diodes (LED) or laser diodes, selectively illuminate a part of the area that can be viewed through the window 122, by means of illuminating radiation, e.g. infrared radiation. An image of the viewed area is projected on the image sensor 106 by means of the lens arrangement. The image sensor may be a two-dimensional CCD or CMOS detector which is triggered to capture images at a fixed or variable rate, typically of about 70-100 Hz.

Power supply for the pen may be a battery 124, which alternatively can be replaced by or supplemented by mains power (not shown).

Digital pen 100 may further be provided with a processing module 126 including one or more processors 128 and a memory block 130. The processing module may be responsible for different functions in the pen, such as position decoding, exposure control, and control of the optical system to avoid specular reflection, and may be implemented by a commercially available microprocessor such as a CPU (“Central Processing Unit”), by a DSP (“Digital Signal Processor”) or by some other programmable logical device, such as an FPGA (“Field Programmable Gate Array”) or alternatively an ASIC (“Application-Specific Integrated Circuit”), discrete analog and digital components, or some combination of the above. The memory block 130 may comprise different types of memory, such as a working memory (e.g. a RAM) and a program code and persistent storage memory (a non-volatile memory, e.g. flash memory). Associated pen software may be stored in memory block 130 and may be executed by the processing module in order to provide a pen control system for the operation of the digital pen.

The casing 120 carries the marking element 107 which allows the user to write or draw physically on a surface by a marking ink being deposited thereon. The marking ink of the marking element 107 is suitably transparent to the illuminating radiation in order to avoid interference with the opto-electronic detection in the digital pen. A contact sensor 132 may be operatively connected to the marking element 107 to detect when the pen is applied to (pen down) and/or lifted from (pen up) the surface, and optionally to allow for determination of the application force. A pen stroke may be defined by a pen down and the next pen up. Based on the output of the contact sensor 132, the optical system may be controlled by the processing module to capture images between a pen down and a pen up. The processing module 126 may then process image data to calculate positions encoded by the imaged parts of the coding pattern. Such processing may e.g. be implemented according to Applicant's prior publications: US 2003/0053699, US 2003/0189664, US 2003/0118233, US 2002/0044138, U.S. Pat. No. 6,667,695, U.S. Pat. No. 6,732,927, US 2003/0122855, US 2003/0128194, and references therein. The resulting sequence of temporally coherent positions forms a digital representation of a pen stroke.

The processing module 126 may furthermore control the optical system to change the image capturing state as has been described above in order to avoid the problems with specularly reflected light. It may also carry out any evaluation which aims at establishing whether a switch to a different image capturing state is to be carried out. Such an evaluation may require the pen orientation to be determined. For that purpose the digital pen may be provided with orientation sensing means (not shown in the Figure), from which the processing module receives orientation values (tilt and/or skew). In another embodiment the processing module 126 may be configured to calculate orientation values using the content of the images.

The digital pen may be a stand-alone device or a device that is intended to transfer recorded data to an external device. In the later case the digital pen may further comprise a communications interface 134 for transmitting or exposing data to a nearby or remote apparatus such as a computer, mobile telephone, PDA, network server, etc. The communications interface 134 may thus provide components for wired or wireless short range communication (e.g. USB, RS232, radio transmission, infrared transmission, ultrasound transmission, inductive coupling, etc), and/or components for wired or wireless remote communication, typically via a computer, telephone or satellite communications network.

The pen may also include an MMI (Man Machine Interface) which may be selectively activated by the pen control system for user feedback. The MMI may include a display, an indicator lamp, a vibrator, a speaker, etc.

Still further, the pen may include one or more buttons by means of which it can be activated and/or controlled.

The digital pen may be configured to transmit recorded information more or less in real time to an external device or to store the information until triggered by the user to transmit the information. In one embodiment the functionality of the pen may be limited to capturing of images and transmission of image information to the external device. In another embodiment, the digital pen may decode position information from the images and perform certain operations in response to the decoded positions.

In another embodiment the digital pen may be configured to be used on a whiteboard to digitally record pen strokes made on the whiteboard. In such case, the marking element may be a complete whiteboard pen which may be inserted in the casing which may be dismountable for that purpose. In this embodiment the contact sensor may be a mechanical switch provided in the upper end of the casing such that the whiteboard pen presses against the switch when the digital pen is used on the whiteboard. The digital pen may or may not leave traces on the whiteboard.

The digital pen need not be an absolute-positioning pen, but it may instead be configured to determine its relative position by matching the content of successively captured images in order to digitally record pen strokes. The pen may also allow for a combination of absolute and relative positioning.

In yet another embodiment the digital pen is a so called point-and-click pen that is not used for recording pen strokes but only to point at a patterned surface in order to initiate an operation or to get some kind of feed-back based on the content of the image. If a point-and-click pen is used on an absolute position coding pattern, the absolute position decoded from the imaged pattern part can for instance represent an instruction to the digital pen to initiate a specific operation or to give a specific kind of feed-back.

Different patterns may be used on a surface to enable the digital pen to determine a relative or absolute position on the surface. The pattern may be made up by more or less complex symbols, and one or more symbols may define a position. In one kind of pattern, each portion of the pattern having a given size may be unique and thereby define a unique, absolute position. Alternatively, the surface may be tiled with pattern portions each defining a position. Pattern portions may be repeated as desired, depending on intended use. The pattern need not be a position-coding pattern. It may alternatively be a non-position-coding pattern, e.g. a randomized pattern, which the digital pen uses for determining its relative position by matching successively captured images.

U.S. Pat. Nos. 6,663,008 and 6,667,695, which are both incorporated herein by reference, disclose a position-coding pattern of the first-mentioned type which could be used by a digital pen for digital recording of handwriting. More particularly, the pattern described in the above-mentioned patents is built up by dots of similar size and shape. Any set of a predetermined number of dots, e.g. 6*6 dots, may define a unique position. As described in the above-mentioned patents, each dot may encode one of four possible values by being displaced in one of four predetermined directions from a grid point in a virtual square grid. The directions of displacements of the different dots may be calculated according to a mathematical algorithm when the pattern is generated. Theoretically, 4³⁶ different positions can be encoded in a pattern having the above-mentioned parameters. The pattern may be implemented with a nominal spacing between the grid points of approximately 0.3 mm, making the pattern suitable for recording handwriting with a high resolution. This pattern arrangement permits the total pattern to cover a surface area roughly equal to the surface area of Europe and Asia combined. Thus, only a tiny percentage or miniscule portion of the total pattern need be provided on a surface, such as surface 102 in FIGS. 1a and 1b, in order to enable it for digital recording of handwriting.

The pattern may be printed on paper stock, translucent material, or may be caused to appear on any surface or material upon which it may be affixed or displayed. For example, pattern may be displayed dynamically such as on a video screen, computer screen, via a projector, or using any other display device.

As an alternative to displaced dots, a pattern allowing recording of handwriting may comprise one or more of dots of different sizes, right angles, slashes, characters, patterns of colours or other printed shapes or indicia.

Examples of other position-coding patterns and digital pens that potentially could use the above-described invention is found e.g. in U.S. Pat. No. 6,752,317; WO99/50787; U.S. Pat. No. 5,661,506; U.S. Pat. No. 5,652,412; U.S. Pat. No. 5,852,434; U.S. Pat. No. 5,442,147; and WO 00/25293.

1-16. (canceled)

17. A digital pen for digital recording of information using a patterned surface, comprising an optical system with at least one sensor for capturing images of the patterned surface while the digital pen is operated on the patterned surface and at least one light source for illuminating the patterned surface when images are captured by the at least one sensor; wherein the optical system is adjustable between at least two image capturing states in which images are captured with a different geometrical arrangement of the at least one sensor and the at least one light source.

18. A digital pen according to claim 17, wherein the optical system comprises at least two light sources and wherein the digital pen is adapted to activate a different light source in a first and second image capturing state.

19. A digital pen according to claim 17, wherein the optical system comprises at least two sensors and wherein the digital pen is adapted to retrieve images from a different image sensor in a first and second image capturing state.

20. A digital pen according to claim 17, wherein at least one of the at least one sensor and the at least one light source is moveable between a first and second position.

21. A digital pen according to claim 17, wherein the digital pen is adapted to switch between the at least two image-capturing states according to a predetermined schedule.

22. A digital pen according to claim 17, wherein the digital pen is adapted to change the image capturing state selectively depending on the operation of the pen.

23. A digital pen according to claim 22, comprising means for determining an orientation of the digital pen, wherein the digital pen is adapted to change the image capturing state selectively based on the orientation of the pen.

24. A digital pen according to claim 17, wherein the digital pen is adapted to electronically record pen strokes by means of an absolute position-coding pattern on the surface.

25. A digital pen for digital recording of information using a patterned surface, comprising an optical system with at least one sensor for capturing images of the patterned surface while the digital pen is operated on the patterned surface and at least one light source for illuminating the patterned surface when images are captured by the at least one sensor; wherein the digital pen is configured to illuminate the patterned surface with linearly polarized light having a first polarization direction and wherein a linear polarizer having a second different polarization direction is provided in front of the at least one image sensor.

26. A digital pen according to claim 25, comprising another linear polarizer in front of the at least one light source for providing the linearly polarized light having a first polarization direction.

27. A digital pen according to claim 25 or 26, wherein the at least one light source is a light source that emits linearly polarized light.

28. A method for digital recording of information using a patterned surface and a digital pen which comprises an optical system with at least one sensor for capturing images of the patterned surface while the digital pen is operated on the patterned surface and at least one light source for illuminating the patterned surface when images are captured by the at least one sensor, the method comprising capturing a first image in a first image capturing state using a first geometrical arrangement of the at least one light sensor and the at least one sensor and capturing a second image in a second image capturing state using a second geometrical arrangement of the at least one light sensor and the at least one sensor.

29. A method according to claim 28, further comprising switching between the image capturing states according to a predetermined schedule.

30. A method according to claim 28, further comprising selectively switching between the image capturing states depending on the operation of the pen.

31. A method according to claim 28, further comprising selectively switching between the image capturing states depending on the orientation of the pen.

32. A method according to claim 28, further comprising recording pen strokes by means of the digital pen by capturing a sequence of images of a surface provided by an absolute position coding pattern and decoding a position from the absolute position coding pattern in the images.
